(19) United States
(12) Patent Application Publication
(10) Pub. No.: US 2025/0053819 A1
(43) Pub. Date: Feb. 13, 2025

(54) COMPRESSION OF LEARNING MODEL

(71) Applicant: Nozomu KUBOTA, Tokyo (JP)

(72) Inventor: Nozomu KUBOTA, Tokyo (JP)

(21) Appl. No.: 18/927,625

(22) Filed: Oct. 25, 2024

Related U.S. Application Data
(63) Continuation of application No. PCT/JP2023/016014, filed on Apr. 21, 2023.

(30) Foreign Application Priority Data
Apr. 27, 2022 (JP) 2022-073380

(51) Int. Cl. G06N 3/09; G06N 3/0495; G06N 3/082; G06N 20/00

(52) U.S. Cl. CPC G06N 3/09; G06N 3/0495; G06N 3/082; G06N 20/00

(57) ABSTRACT

An information processing method executed by one or a plurality of processors included in an information processing apparatus includes: acquiring predetermined learning data; performing machine learning by inputting predetermined data to a weight learning model, in which each model including at least two models from among compressed models is weighted, for a predetermined learning model using a neural network; acquiring a learning result in a case where the machine learning is performed by inputting the predetermined learning data for each weight learning model; performing supervised learning by using learning data including each weight learning model and each learning result obtained when learned by each of the weight learning models; and generating a prediction model that predicts a learning result for each set of weights in a case where arbitrary learning data is input by the supervised learning.

### TECHNICAL FIELD

The present invention relates to an information processing method, a program, and an information processing apparatus related to compression of a learning model.

### BACKGROUND ART

In recent years, studies for compression of a learning model have been conducted. For example, Patent Document 1 below describes a technology for compression of a learning model using parameter quantization.

### CITATION LIST

### Patent Document

Patent Document 1: Patent Publication JP-A-2019-133628

### SUMMARY

### Technical Problem

Here, there are methods for compression of a learning model, such as pruning, quantization, and distillation. At least one of these compression methods is applied to the learning model, whereby an engineer appropriately adjusts parameters to implement compression.

However, it is considered that an appropriate compression method varies depending on various conditions such as learning data and learning models, but the compression method, even if determined by an engineer appropriately adjusting parameters, is not necessarily an optimal method.

Therefore, an object of the present invention is to provide an information processing method, a program, and an information processing apparatus that enable a compression method for a learning model to be more appropriate.

### Solution to Problem

An information processing method according to an aspect of the present invention executed by one or a plurality of processors included in an information processing apparatus includes: acquiring predetermined learning data; performing machine learning by inputting predetermined data to a weight learning model, in which each model including at least two models from among a first learning model subjected to distillation processing, a second learning model subjected to pruning processing, and a third learning model subjected to quantization processing is weighted, for a predetermined learning model using a neural network; acquiring a learning result in a case where the machine learning is performed by inputting the predetermined learning data for each weight learning model in which a weight of each of the models is changed; performing supervised learning by using learning data including each weight learning model to which each changed weight is given and each learning result obtained when learned by each of the weight learning models; and generating a prediction model that predicts a learning result for each set of weights in a case where arbitrary learning data is input by the supervised learning.

### Advantageous Effects of Invention

According to the present invention, it is possible to provide an information processing method, a program, and an information processing apparatus that enable a compression method for a learning model to be more appropriate.

### BRIEF DESCRIPTION OF DRAWINGS

FIG. 1 is a diagram illustrating an example of a system configuration according to an embodiment.

FIG. 2 is a diagram illustrating an example of a physical configuration of an information processing apparatus according to the embodiment.

FIG. 3 is a diagram illustrating an example of processing blocks of the information processing apparatus according to the embodiment.

FIG. 4 is a diagram for describing distillation of a trained model.

FIG. 5 is a diagram for describing pruning of the trained model.

FIG. 6 is a diagram illustrating an example of processing blocks of the information processing apparatus according to the embodiment.

FIG. 7 is a diagram illustrating an example of relationship information according to the embodiment.

FIG. 8 is a diagram illustrating a display example of the relationship information according to the embodiment.

FIG. 9 is a flowchart illustrating an example of processing related to generation of a prediction model according to the embodiment.

FIG. 10 is a flowchart illustrating an example of processing in the information processing apparatus used by a user according to the embodiment.

### DESCRIPTION OF EMBODIMENTS

Embodiments of the present invention will be described with reference to the accompanying drawings. Note that, in the respective drawings, components denoted by the same reference numerals have the same or similar configurations.

### Embodiment

### <System Configuration>

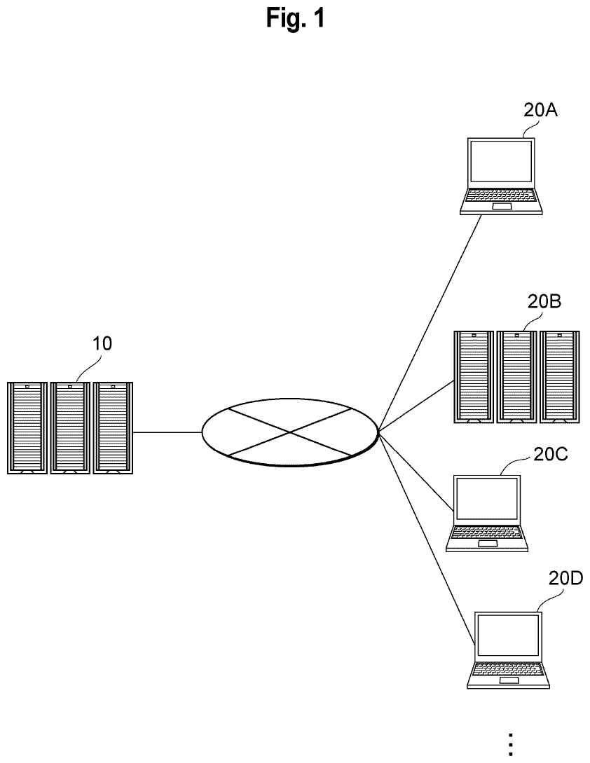

FIG. 1 is a diagram illustrating an example of a system configuration according to an embodiment. In the example illustrated in FIG. 1, a server 10 and each of information processing apparatuses 20A, 20B, 20C, and 20D are connected so as to be able to transmit and receive data via a network. In a case where the information processing apparatuses are not individually distinguished, the information processing apparatuses are also referred to as an information processing apparatus 20.

The server 10 is an information processing apparatus capable of collecting and analyzing data, and may include one or more information processing apparatuses. The information processing apparatus 20 is an information processing apparatus capable of performing machine learning, such as a smartphone, a personal computer, a tablet terminal, a server, or a connected car. The information processing apparatus 20 may be directly or indirectly connected to an invasive or non-invasive electrode that senses brain waves, and may be an apparatus capable of analyzing and transmitting/receiving brain wave data.

In the system illustrated in FIG. 1, for example, the server 10 applies various compression methods (compression algorithms) to a learning model trained using predetermined learning data. Various compression methods include applying one existing compression method or applying a combination of any compression methods. At this time, the server 10 stores a predetermined dataset, a predetermined learning model, and a learning result at the time of using a predetermined compression method in association with each other.

Next, the server 10 trains and generates a prediction model that specifies a compression method whose learning result is appropriate, by using an arbitrary dataset, an arbitrary compression method, and learning results thereof (for example, learning accuracy) as training data. The appropriateness of the learning result is determined by, for example, the learning accuracy and a compression rate of a model size.

Therefore, it becomes possible to more appropriately compress the trained learning model. Furthermore, the server 10 may appropriately adjust each weight that defines an application ratio of each compression method by using a model that is a linear combination of the weighted compression methods.

### <Hardware Configuration>

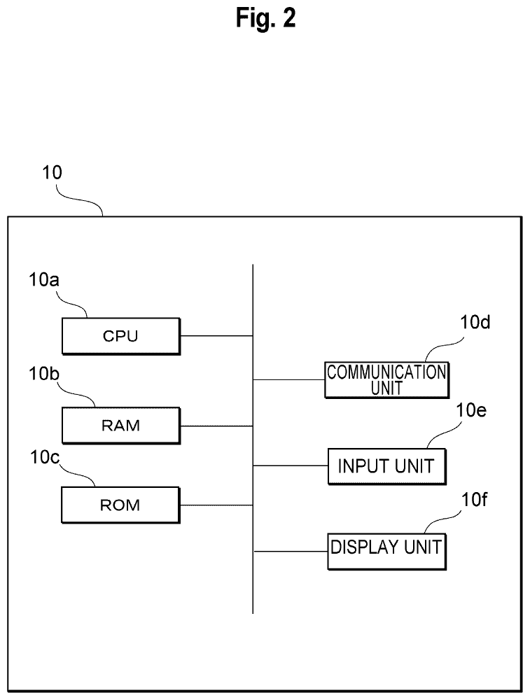

FIG. 2 is a diagram illustrating an example of a physical configuration of an information processing apparatus 10 according to the embodiment. The information processing apparatus 10 includes one or more central processing units (CPUs) 10a corresponding to an arithmetic unit, a random access memory (RAM) 10b corresponding to a storage unit, a read only memory (ROM) 10c corresponding to a storage unit, a communication unit 10d, an input unit 10e, and a display unit 10f. The components are connected via a bus so as to be able to transmit and receive data to and from each other.

In the embodiment, a case where the information processing apparatus 10 is implemented by one computer will be described, but the information processing apparatus 10 may also be implemented by combining a plurality of computers or a plurality of arithmetic units. Furthermore, the components illustrated in FIG. 2 are examples, and the information processing apparatus 10 may include other components or does not include some of the components.

The CPU 10a is a control unit that performs control related to execution of a program stored in the RAM 10b or the ROM 10c, and calculation and processing of data. The CPU 10a is an arithmetic unit that executes a program (learning program) for performing learning using a learning model for examining a more appropriate compression method and a program (prediction program) for performing learning for generating a prediction model that outputs an appropriate compression method when arbitrary data is input. The CPU 10a receives various data from the input unit 10e and the communication unit 10d, and displays a data calculation result on the display unit 10f or stores the data calculation result in the RAM 10b.

Data can be rewritten in the RAM 10b among the storage units, and the RAM 10b may be implemented by, for example, a semiconductor storage element. The RAM 10b may store data such as a program to be executed by the CPU 10a, compression data (for example, compression algorithm) regarding various compression methods, a prediction model that predicts an appropriate compression method, and relationship information indicating a correspondence relationship between information regarding data to be learned and an appropriate compression method corresponding to the data. Note that such data are examples, and data other than the above-described data may be stored in the RAM 10b, or some of the above-described data do not have to be stored.

Data can be read from the ROM 10c among the storage units, and the ROM 10c may be implemented by, for example, a semiconductor storage element. The ROM 10c may store, for example, the learning program or data that is not rewritten.

The communication unit 10d is an interface that connects the information processing apparatus 10 to another device. The communication unit 10d may be connected to a communication network such as the Internet.

The input unit 10e receives data from a user, and may include, for example, a keyboard and a touch panel.

The display unit 10f visually displays a calculation result of the CPU 10a, and may be implemented by, for example, a liquid crystal display (LCD). The display of the calculation result by the display unit 10f can contribute to explainable AI (XAI). The display unit 10f may display, for example, a learning result and information regarding a learning model.

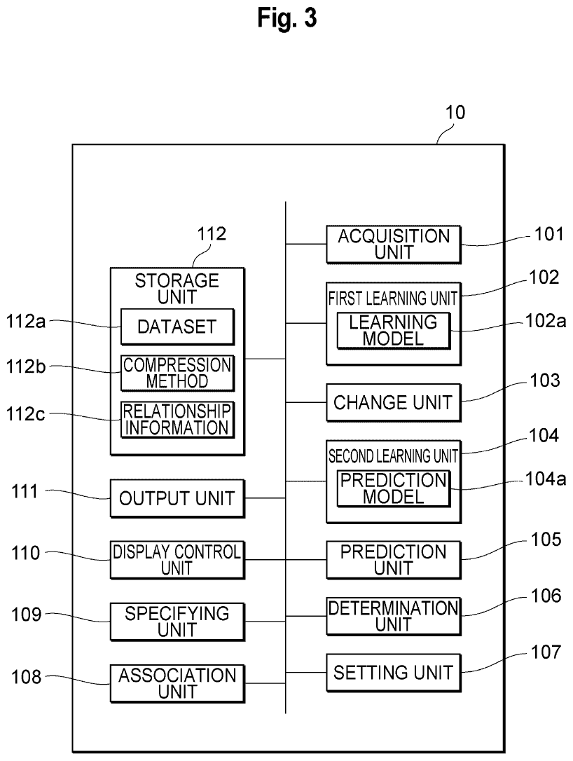

The learning program may be provided by being stored in a computer-readable storage medium such as the RAM 10b or the ROM 10c, or may be provided via a communication network connected by the communication unit 10d. In the information processing apparatus 10, the CPU 10a executes the learning program to implement various operations described below with reference to FIG. 3. Note that the physical components are merely examples, and do not have to necessarily be independent components. For example, the information processing apparatus 10 may include a large-scale integration (LSI) in which the CPU 10a, the RAM 10b, and the ROM 10c are integrated. Furthermore, the information processing apparatus 10 may include a graphical processing unit (GPU) or an application specific integrated circuit (ASIC).

Note that the configuration of the information processing apparatus 20 is similar to the configuration of the information processing apparatus 10 illustrated in FIG. 2, and thus a description thereof will be omitted. Furthermore, the information processing apparatus 10 and the information processing apparatus 20 only need to include the CPU 10a, the RAM 10b, and the like that are basic components for performing data processing, and the input unit 10e and the display unit 10f do not have to be provided. Furthermore, the input unit 10e and the display unit 10f may be connected from the outside using an interface.

### <Processing Configuration>

FIG. 3 is a diagram illustrating an example of processing blocks of the information processing apparatus 10 according to the embodiment. The information processing apparatus 10 includes an acquisition unit 101, a first learning unit 102, a change unit 103, a second learning unit 104, a prediction unit 105, a determination unit 106, a setting unit 107, an association unit 108, a specifying unit 109, a display control unit 110, an output unit 111, and a storage unit 112. For example, the first learning unit 102, the change unit 103, the second learning unit 104, the prediction unit 105, the determination unit 106, the setting unit 107, the association unit 108, the specifying unit 109, and the display control unit 110 illustrated in FIG. 3 can be implemented by, for example, the CPU 10a, the acquisition unit 101 and the output unit 111 can be implemented by, for example, the communication unit 10d, and the storage unit 112 can be implemented by the RAM 10b and/or the ROM 10c.

The acquisition unit 101 acquires predetermined learning data. For example, the acquisition unit 101 may acquire a known dataset such as image data, series data, or text data as the predetermined learning data. The acquisition unit 101 may acquire data stored in the storage unit 112 or may acquire data transmitted by another information processing apparatus.

In order to solve a predetermined problem, the first learning unit 102 performs machine learning by inputting the predetermined learning data to a weight learning model in which each model including at least two of a first learning model subjected to distillation processing, a second learning model subjected to pruning processing, and a third learning model subjected to quantization processing is weighted for a predetermined learning model 102a using a neural network.

Here, as an example of a compression method for the trained learning model 102a, algorithms of distillation, pruning, and quantization will be briefly described below.

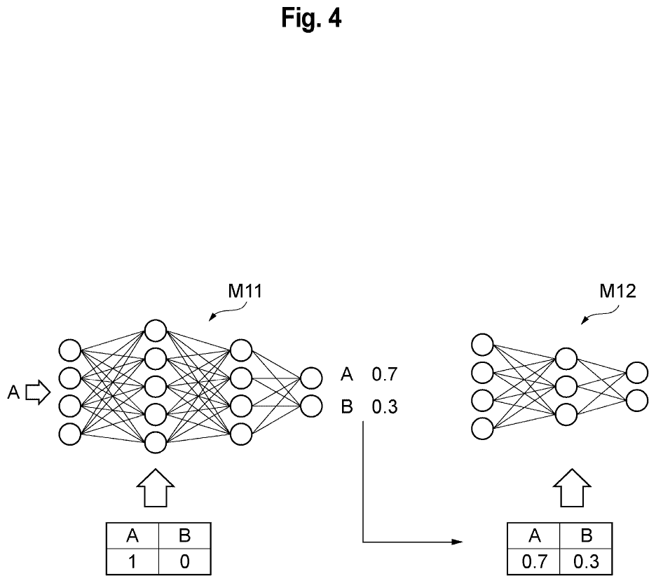

FIG. 4 is a diagram for describing distillation of a trained model. In the distillation illustrated in FIG. 4, compression is performed by training a smaller model M12 using a prediction result of the trained model M11 as teacher data. At this time, the smaller model M12 may have the same degree of accuracy as the larger model M11.

For example, in the distillation, the trained model M11 is called a Teacher model, and the smaller model M12 is called a Student model. The Student model is appropriately designed by an engineer.

In the example illustrated in FIG. 4, learning data using a classifier as an example will be described. The Teacher model that is the model M11 performs learning by using teacher data which is expressed by 0 and 1 and in which 1 is a correct answer. On the other hand, the Student model that is the model M12 learns values (example: A=0.7 and B=0.3) output by the Teacher model as the teacher data. In the embodiment, a plurality of different post-distillation models M11 may be prepared for one learning model M12.

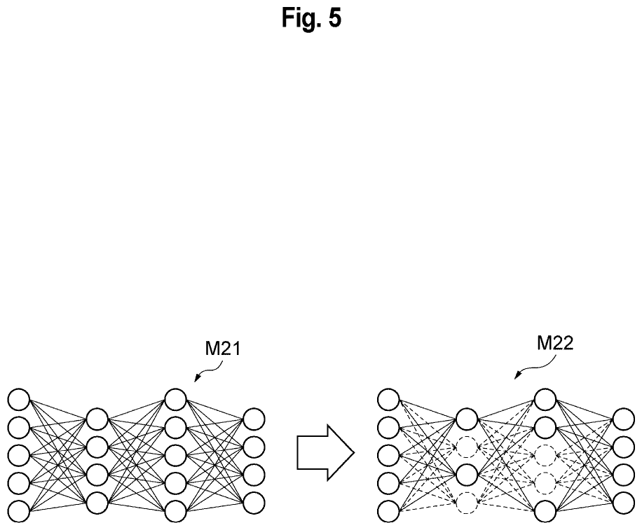

FIG. 5 is a diagram for describing pruning of a trained model. In the pruning illustrated in FIG. 5, a weight and a node of a trained model M21 are deleted to generate a compressed model M22. As a result, it becomes possible to reduce the number of time calculation is performed and a memory usage.

In the pruning method, deletion may be performed on a portion having a small weight in connection between nodes. For example, in the pruning, it is not necessary to separately design a model unlike the distillation. However, since parameters are deleted, relearning may be performed to maintain the learning accuracy. For example, the compression may be performed by cutting a branch (edge) having a small influence on learning, for example, a branch having a weight of a predetermined value or less.

In the quantization, a parameter included in a model is expressed with a small number of bits. As a result, it becomes possible to compress the model without changing a network structure. For example, in a case where a simple network having 6 weight parameters is taken as an example, a total of 192 bits is required in the case of 32-bit accuracy, but in the case of a constraint of 8-bit accuracy, the parameters are expressed with a total of 48 bits, so that compression is made.

Returning to FIG. 3, for example, the first learning unit 102 selects at least two compression models from among the first model, the second model, and the third model for the trained learning model 102a, and sets a default weight as a weight given to each model.

The first model, the second model, and the third model may be set in advance for each category of the trained model, or may be automatically generated for each trained model according to a predetermined standard. For example, in the case of the distillation, the first learning unit 102 may determine a post-distillation model suitable for the trained model by machine learning. In the case of the pruning, the first learning unit 102 may cut a branch having a weight that is equal to or less than a predetermined value to generate a post-pruning model. In the case of the quantization, the first learning unit 102 may set a constraint (quantization) of predetermined bit accuracy. In addition, a plurality of first models, a plurality of second models, and a plurality of third models may be set for one trained model, and a weight may be given to each model.

The predetermined problem includes, for example, a problem of performing at least one of classification, generation, and optimization on at least one of image data, series data, and text data. Here, the image data includes still image data and moving image data. The series data includes voice data and stock price data.

Furthermore, the predetermined learning model 102a is a trained learning model including the neural network, and includes, for example, at least one of an image recognition model, a series data analysis model, a robot control model, a reinforcement learning model, a speech recognition model, a speech generation model, an image generation model, and a natural language processing model. Furthermore, as a specific example, the predetermined learning model 102a may be any one of a convolutional neural network (CNN), a recurrent neural network (RNN), a deep neural network (DNN), a long short-term memory (LSTM), a bidirectional LSTM, a deep Q-network (DQN), a variational autoencoder (VAE), a generative adversarial network (GAN), a flow-based generation model, and the like.

The change unit 103 changes each weight of the predetermined learning data and/or weight learning model. For example, the change unit 103 sequentially changes the predetermined learning data input to the first learning unit 12 one by one from among a plurality of pieces of learning data. Furthermore, in a case where all of the pieces of predetermined learning data have been input to a certain weight learning model and learning has been performed, the change unit 103 may select one set from among sets of a plurality of weights in order to use another weight of the weight learning model, perform learning using all the prepared sets, and acquire a learning result.

In addition, the first learning unit 102 inputs the predetermined learning data to the weight learning model, and performs learning of a hyperparameter or the like for the weight learning model such that an appropriate learning result is output. At this time, when the hyperparameter is updated (adjusted), the first learning unit 102 also adjusts each weight given to each model of the weight learning model by a predetermined method.

For example, as for the adjustment of each weight, the weights may be sequentially adjusted from an initial value set in advance. At this time, any adjustment method may be used as long as the weights are all added to be adjusted to 1, and adjustment different from the previously performed adjustment is performed. For example, the first learning unit 102 sequentially changes the weights by a predetermined value, and changes all combinations. For example, the first learning unit 102 subtracts a predetermined value from an initial value of a weight wₖ and adds a predetermined value to an initial value of a weight wₖ₊₁, and when any one of the weights becomes 0 or less, the first learning unit 102 adds 1 to k to repeat the change from each initial value. In addition, there is no need to provide a condition that all the weights are added to be 1, and in this case, it is sufficient if the weights are added to be finally adjusted to be 1 by using a Softmax function or the like.

As a result, it is possible to cause an arbitrary combination of the predetermined learning data and a predetermined set of weights to be learned. For example, the change unit 103 may sequentially change the predetermined learning data and/or the predetermined set of weights one by one such that all combinations of the predetermined learning data and the predetermined set of weights are learned, or may sequentially change the predetermined learning data and/or the predetermined set of weights one by one until a predetermined condition is satisfied. The predetermined condition may be set based on, for example, the learning accuracy and the compression rate of the model size.

The acquisition unit 101 or the first learning unit 102 acquires a learning result in a case where machine learning is performed by inputting the predetermined learning data for each weight learning model in which the weight of each model has been changed. For example, the acquisition unit 101 or the first learning unit 102 acquires learning results obtained using various combinations of the pieces of predetermined learning data and/or predetermined sets of weights.

Here, the weight learning model will be described using a specific example. For example, the first learning unit 102 may use a weight learning model that is a linear combination of the first model, the second model, and the third model with weights w₁, w₂, and w₃ given to the first model, the second model, and the third model, respectively. An example of a weight learning function M(x) in this case is as Formula (1) which is merely an example.

$${M}_{1} ( x ) = {w}_{1} {m}_{1} ( x ) + {w}_{2} {m}_{2} ( x ) + {w}_{3} {m}_{3} ( x ) \qquad Formula ( 1 )$$

wₙ: weight (a set of weights is also denoted as W)
mₙ(x): n-th model
x: learning data

For example, the change unit 103 sequentially changes the weights one by one according to a predetermined standard such that w₁+w₂+w₃=1. The first learning unit 102 acquires a learning result for each weight after the change, and associates the learning result with each set of weights. The learning result is the compression rate of the model size indicating the learning accuracy and the effect of compression. The compression rate of the model size is, for example, a ratio of the number of parameters of the trained model after compression to the number of parameters of the trained model before compression.

Further, when the change unit 103 changes the predetermined learning data, the first learning unit 102 trains the weight learning model with each set of weights for the changed learning data as described above, and acquires the learning result. As a result, training data including arbitrary learning data, an arbitrary set of weights, and learning results in these cases is generated.

The second learning unit 104 performs supervised learning by using learning data including each weight learning model to which each changed weight is given and each learning result when learned by each weight learning model. For example, the second learning unit 104 performs supervised learning by using training data in which a learning result (for example, learning performance and/or the compression rate of the model size) obtained when learning is performed using arbitrary learning data and an arbitrary set of weights is set as a correct answer label.

In addition, the second learning unit 104 generates a prediction model 104a that predicts a learning result for each set of weights in a case where arbitrary learning data is input by supervised learning. For example, when arbitrary learning data is input, the second learning unit 104 generates a prediction model that outputs the learning accuracy and the compression rate of the model size for each set of weights of each compression method for the learning data.

With the above configuration, it is possible to generate a prediction model that predicts a learning result for each set of weights by performing supervised learning using, as training data, various learning data and learning results obtained using each learning model compressed by various compression methods. As a result, a more appropriate compression method can be used by using the prediction model generated by the second learning unit 104.

The prediction unit 105 inputs arbitrary learning data to the prediction model 104a, and predicts a learning result in a case where the weight learning model is executed for each set of weights of each model. For example, in a case where a dataset of an image is input as the learning data, the prediction unit 105 predicts the learning accuracy and a value (for example, the compression rate) related to the model size for each specific set Wₙ of weights (w₁ₙ, w₂ₙ, and w₃ₙ).

As a result, the learning result is predicted for each set of weights indicating how much each compression method is applied to arbitrary data (for example, the dataset), and thus, it is possible to select each weight that is more appropriate based on the learning result.

The determination unit 106 determines whether or not a learning result in a case where arbitrary learning data is input to the predetermined learning model 102a and a learning result predicted by the prediction model 104a satisfy a predetermined condition regarding compression. For example, the determination unit 106 determines whether or not a first difference value between learning accuracy A1 when learning data A is input to the trained learning model 102a before compression and learning accuracy B1 predicted by the prediction model 104a is equal to or smaller than a first threshold value. The smaller the first difference value, the better the learning accuracy can be maintained even after the compression of the learning model, and each weight in the case of the learning accuracy B1 is an appropriate compression method.

In addition, the determination unit 106 determines whether or not a second difference value between a compression rate A2 (=1) of the trained learning model 102a before compression and a compression rate B2 predicted by the prediction model 104a is equal to or larger than a second threshold value. The larger the second difference value, the more the learning model can be compressed.

The determination unit 106 determines the effectiveness of each weight based on the determination result regarding compression. For example, the determination unit 106 determines that each weight with which a high compression rate B2 is secured and the learning accuracy B1 can maintain the accuracy before compression is an effective compression method based on the first difference value and the second difference value. As a specific example, the determination unit 106 may determine each weight of which the first difference value is equal to or smaller than the first threshold value and the second difference value is equal to or larger than the second threshold value as an effective compression method, and determine others weights as ineffective compression methods.

As a result, it is possible to select each appropriate weight with reference to each prediction value based on the value (for example, the compression rate) related to the model size and the learning accuracy. For example, the determination unit 106 may select each weight with which the highest learning accuracy can be secured, or may select each weight with which the compression rate that is equal to or larger than the second threshold value and the highest learning accuracy can be secured.

The setting unit 107 receives a user operation related to a predetermined condition related to compression. For example, when the user operates the input unit 10e to input the predetermined condition related to compression through a condition input screen displayed on the display unit 10f, the setting unit 107 receives the input operation.

The setting unit 107 sets the predetermined condition related to compression as a determination condition of the determination unit 106 based on the received user operation. For example, the setting unit 107 may be able to set the first threshold value related to the learning performance and/or the second threshold value related to the model size based on the input operation of the user.

As a result, it becomes possible to specify an effective compression method by using conditions desired by the user.

The association unit 108 sets the learning accuracy included in the learning result as a first variable and the value (for example, the compression rate) related to the model size included in the learning result as a second variable, and generates the relationship information in which the first variable and the second variable are associated with each weight. For example, in a case where the vertical axis represents the first variable and the horizontal axis represents the second variable, the association unit 108 may generate a matrix in which each weight W is associated with an intersection of the variables. Furthermore, the association unit 108 may generate the relationship information (actual measurement relationship information) in which the first variable and the second variable are associated with each weight W based on the learning accuracy and the compression rate acquired from each information processing apparatus 20.

With the above processing, when the first variable or the second variable is changed, each corresponding weight W can be quickly specified. In addition, the first variable and the second variable may be appropriately changed. For example, the learning accuracy may be applied as the first variable, the weight W may be applied as the second variable, and the value related to the model size may be information to be specified.

In addition, the acquisition unit 101 may acquire a first value of the first variable and a second value of the second variable. For example, the acquisition unit 101 acquires the first value of the first variable and the second value of the second variable designated by the user. The first value or the second value is appropriately designated by the user.

In this case, the specifying unit 109 specifies each weight W corresponding to the first value of the first variable and the second value of the second variable based on the relationship information generated by the association unit 108. For example, the specifying unit 109 specifies each weight W corresponding to the value of the first variable or the value of the second variable to be changed by using the relationship information.

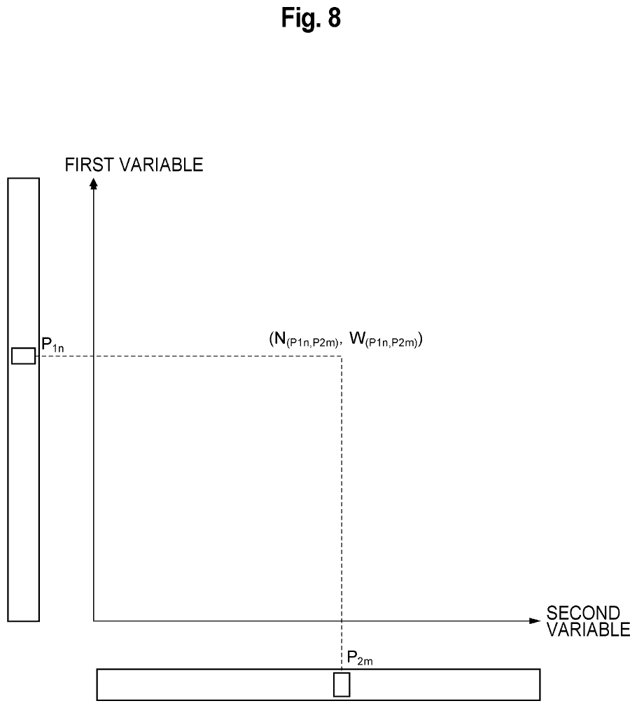

The display control unit 110 performs display control of each weight W specified by the specifying unit 109 on a display device (display unit 10f). Furthermore, the display control unit 110 may display a matrix in which the first variable and the second variable are changeable by a graphical user interface (GUI) (for example, FIG. 8 and the like described below).

With the above processing, each weight W specified according to the first variable or the second variable designated by the user can be visualized for the user. The user can specify each desired weight W by changing the first variable or the second variable and apply the weight W to the compression of the trained model.

The output unit 111 may output each weight W predicted by the second learning unit 104 to another information processing apparatus 20. For example, the output unit 111 may output each appropriate weight W corresponding to the predetermined learning data to the information processing apparatus 20 that has transmitted the predetermined learning data and has requested acquisition of each appropriate weight W. Furthermore, the output unit 111 may output each predicted weight W to the storage unit 112.

The storage unit 112 stores data regarding learning. The storage unit 112 stores a predetermined dataset 112a, data regarding a compression method 112b, relationship information 112c described above, training data, data in the middle of learning, information regarding a learning result, and the like.

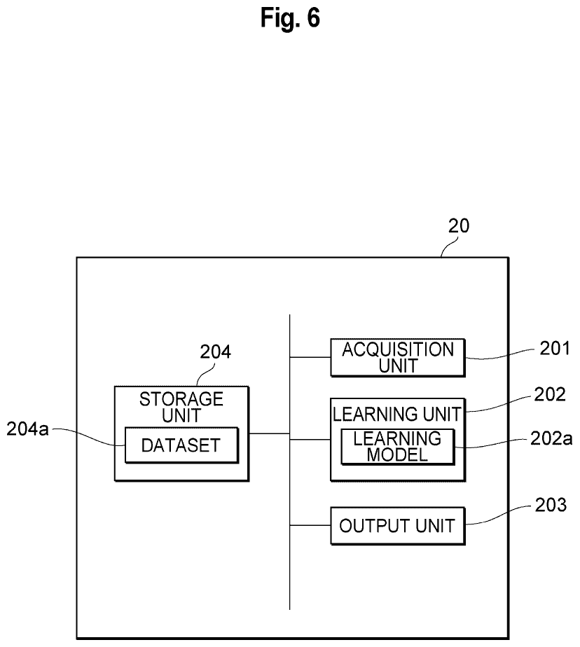

FIG. 6 is a diagram illustrating an example of processing blocks of the information processing apparatus 20 according to the embodiment. The information processing apparatus 20 includes an acquisition unit 201, a learning unit 202, an output unit 203, and a storage unit 204. The information processing apparatus 20 may be implemented by a general-purpose computer.

The acquisition unit 201 may acquire information regarding a predetermined weight learning model and information regarding a predetermined dataset together with a distributed learning instruction by another information processing apparatus (for example, the server 10). The information regarding the predetermined weight learning model may be information indicating each weight or information indicating the weight learning model itself. The information regarding the predetermined dataset may be the dataset itself or information indicating a storage destination in which the predetermined dataset is to be stored.

The learning unit 202 performs learning by inputting a predetermined dataset to be learned to a predetermined weight learning model 202a. The learning unit 202 performs control to feed back a learning result after learning to the server 10. The learning result includes, for example, learning performance and the like, and may further include information regarding the model size. The learning unit 202 may select the learning model 202a according to the type of a dataset to be learned and/or a problem to be solved.

Furthermore, the predetermined weight learning model 202a is a learning model including a neural network, and includes, for example, a model in which each compression method is weighted based on at least one of an image recognition model, a series data analysis model, a robot control model, a reinforcement learning model, a speech recognition model, a speech generation model, an image generation model, a natural language processing model, and the like. Furthermore, as a specific example, a base of the predetermined weight learning model 202a may be any one of a convolutional neural network (CNN), a recurrent neural network (RNN), a deep neural network (DNN), a long short-term memory (LSTM), a bidirectional LSTM, a deep Q-network (DQN), a variational autoencoder (VAE), a generative adversarial network (GAN), a flow-based generation model, and the like.

The output unit 203 outputs information regarding a learning result of the distributed learning to another information processing apparatus. For example, the output unit 203 outputs information regarding a learning result of the learning unit 202 to the server 10. For example, the information regarding the learning result of the distributed learning includes the learning performance and may further include the information regarding the model size, as described above.

The storage unit 204 stores data regarding the learning unit 202. The storage unit 204 stores a predetermined dataset 204a, data acquired from the server 10, data in the middle of learning, information regarding a learning result, and the like.

As a result, the information processing apparatus 20 can perform distributed learning to which the predetermined weight learning model is applied for the predetermined dataset and feed back the learning result to the server 10 according to an instruction from another information processing apparatus (for example, the server 10).

Furthermore, the output unit 203 outputs information regarding predetermined data to another information processing apparatus (for example, the server 10). The output unit 203 may output predetermined data (for example, a dataset to be learned) or may output feature information of the predetermined data.

The acquisition unit 201 may acquire each weight W corresponding to the predetermined data from another information processing apparatus. Each weight W to be acquired is each weight suitable for the predetermined data, predicted by another information processing apparatus using a prediction model.

The learning unit 202 applies each acquired weight to the weight learning model 202a. At this time, the weight learning model 202a may apply each weight to the weight learning model 202a used for the above-described learning. Furthermore, the weight learning model 202a may be a learning model acquired from another information processing apparatus 10 or a learning model managed by the own apparatus.

The learning unit 202 inputs predetermined data to the weight learning model 202a to which each weight is applied and acquires a learning result. The learning result is a result of learning using each weight suitable for the predetermined data. The learning unit 202 can use a learning model that is appropriately compressed while maintaining the learning performance.

### <Data Example>

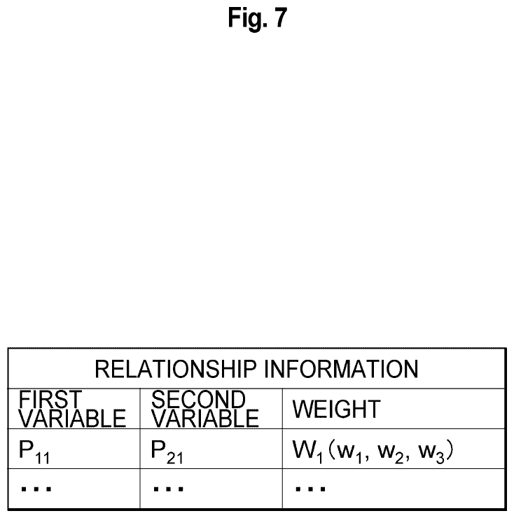

FIG. 7 is a diagram illustrating an example of the relationship information according to the embodiment. In the example illustrated in FIG. 7, the relationship information includes each weight (for example, W₁) corresponding to each first variable (for example, P₁₁) and each second variable (for example, P₂₁). The first variable Pin is, for example, the learning accuracy, the second variable P₂ₙ is, for example, the compression rate of the model size, and only one of the variables may be used as the variable. Each weight W_{(P1n,P2m)} is a weight in the case of the first variable P₁ₙ and the second variable P₂ₙ.

For the relationship information illustrated in FIG. 7, the server 10 acquires the learning accuracy (first variable) and the compression rate (second variable) from the information processing apparatus 20 that has performed distributed learning with a predetermined combination of the number of distributed instances and hyperparameters or from a result of supervised learning of the own apparatus. The server 10 associates each weight W with the acquired learning accuracy and compression rate. The server 10 can generate the relationship information illustrated in FIG. 7 by acquiring the learning accuracy and the compression rate actually measured by the supervised learning each time. Furthermore, as the relationship information, predicted relationship information for an arbitrary dataset may be generated based on a result predicted by the prediction unit 105.

### <Example of User Interface>

FIG. 8 is a diagram illustrating a display example of the relationship information according to the embodiment. In the example illustrated in FIG. 8, the first variable and the second variable included in the relationship information can be changed using a slide bar. When the user moves the first variable or the second variable by using the slide bar, for example, the set W_{(P1n,P2m)} of weights W corresponding to the first variable (P₁ₙ) or the second variable (P₂ₘ) after the movement is displayed in association with a corresponding point.

Furthermore, the user may designate a predetermined point on a two-dimensional graph of the first variable and the second variable to display a combination of learning accuracy and a compression rate corresponding to the designated point.

As a result, the server 10 can display each appropriate weight W corresponding to the combination of the first variable and the second variable. Furthermore, it is possible to provide a user interface that enables selection of an appropriate number of distributed instances and hyperparameters for an arbitrary dataset for which distributed learning is to be performed while visually indicating a correspondence relationship to the user.

### <Operation>

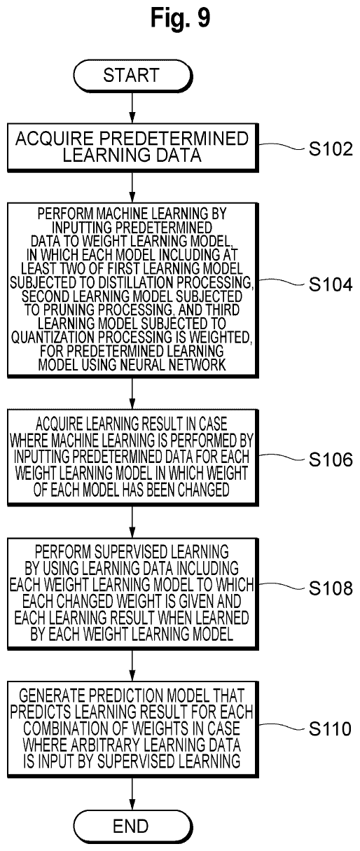

FIG. 9 is a flowchart illustrating an example of processing related to generation of the prediction model according to the embodiment. The processing illustrated in FIG. 9 is performed by the information processing apparatus 10.

In step S102, the acquisition unit 101 of the information processing apparatus 10 acquires predetermined learning data. The predetermined learning data may be selected from the dataset 112a of the storage unit 112 or may be predetermined data received from another apparatus via a network, or predetermined data input according to a user operation may be acquired.

In step S104, the first learning unit 102 of the information processing apparatus 10 performs machine learning by inputting the predetermined data to a weight learning model in which each model including at least two of the first learning model subjected to distillation processing, the second learning model subjected to pruning processing, and the third learning model subjected to quantization processing is weighted for a predetermined learning model using a neural network.

In step S106, the second learning unit 104 of the information processing apparatus 10 acquires a learning result in a case where machine learning is performed by inputting the predetermined learning data for each weight learning model in which the weight of each model has been changed.

In step S108, the second learning unit 104 of the information processing apparatus 10 performs supervised learning by using learning data including each weight learning model to which each changed weight is given and each learning result when learned by each weight learning model.

In step S110, the second learning unit 104 of the information processing apparatus 10 generates a prediction model that predicts a learning result for each combination of weights in a case where arbitrary learning data is input by supervised learning.

According to the above processing, by using the generated prediction model, it is possible to more appropriately compress a trained model using a neural network while maintaining learning accuracy.

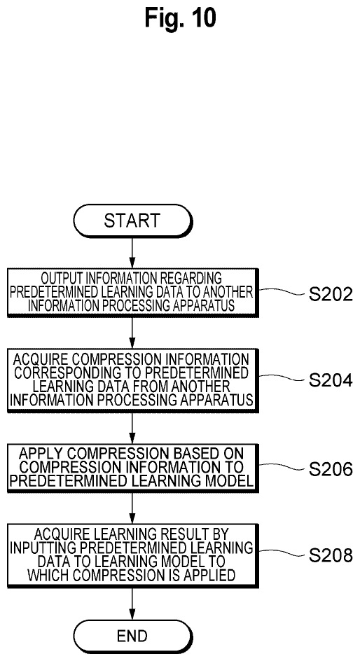

FIG. 10 is a flowchart illustrating an example of processing in the information processing apparatus 20 used by the user according to the embodiment. In step S202, the output unit 203 of the information processing apparatus 20 outputs information regarding predetermined learning data to be learned to another information processing apparatus (for example, the server 10).

In step S204, the acquisition unit 201 of the information processing apparatus 20 acquires information indicating each weight corresponding to the predetermined learning data from another information processing apparatus (for example, the server 10).

In step S206, the learning unit 202 of the information processing apparatus 20 applies each acquired weight to the predetermined weight learning model 202a.

In step S208, the learning unit 202 of the information processing apparatus 20 inputs the predetermined learning data to the learning model 202a to which each weight is applied, and acquires a learning result.

As a result, even an edge-side information processing apparatus can maintain the learning accuracy by performing learning using an appropriately compressed learning model for data to be learned.

The embodiment described above is intended to facilitate understanding of the present invention, and is not intended to limit the present invention. Each element included in the embodiment and the arrangement, material, condition, shape, size, and the like thereof are not limited to those exemplified, and can be appropriately changed. Furthermore, the apparatus including the first learning unit 102 and the apparatus including the second learning unit 104 may be different computers. In this case, the generated learning result of the first learning unit 102 may be transmitted to the apparatus including the second learning unit 104 via a network.

Furthermore, the information processing apparatus 10 does not have to necessarily include the change unit 103. For example, the information processing apparatus 10 may acquire each learning performance of a set of arbitrary data to be learned and an arbitrary set of weights and perform learning by the second learning unit 104.

### REFERENCE SIGNS LIST

10 Information processing apparatus
10a CPU
10b RAM
10c ROM
10d Communication unit
10e Input unit
10f Display unit
101 Acquisition unit
102 First learning unit
102a Learning model
103 Change unit
104 Second learning unit
104a Prediction model
105 Prediction unit
106 Determination unit
107 Setting unit
108 Association unit
109 Specifying unit
110 Display control unit
111 Output unit
112 Storage unit
112a Dataset
112b Compression method
112c Relationship information
201 Acquisition unit
202 Learning unit
202a Learning model
203 Output unit
204 Storage unit
204a Dataset

What is claimed is:

1. An information processing method executed by one or a plurality of processors included in an information processing apparatus, the information processing method comprising:
acquiring predetermined learning data;
performing machine learning by inputting predetermined data to a weight learning model, in which each model including at least two models from among a first learning model subjected to distillation processing, a second learning model subjected to pruning processing, and a third learning model subjected to quantization processing is weighted, for a predetermined learning model using a neural network;
acquiring a learning result in a case where the machine learning is performed by inputting the predetermined learning data for each weight learning model in which a weight of each of the models is changed;
performing supervised learning by using learning data including each weight learning model to which each changed weight is given and each learning result obtained when learned by each of the weight learning models; and
generating a prediction model that predicts a learning result for each set of weights in a case where arbitrary learning data is input by the supervised learning.

2. The information processing method according to claim 1, further comprising, by the one or plurality of processors, inputting arbitrary learning data to the prediction model and predicting a learning result in a case where the weight learning model is executed for each set of weights.

3. The information processing method according to claim 2, further comprising: by the one or plurality of processors,
determining whether or not a learning result in a case where the arbitrary learning data is input to the predetermined learning model and a learning result predicted by the prediction model satisfy a predetermined condition related to compression; and
determining validity of each weight, based on a determination result for the predetermined condition.

4. The information processing method according to claim 3, further comprising: by the one or plurality of processors,
receiving a user operation related to the predetermined condition related to compression; and
setting the predetermined condition related to compression, based on the user operation.

5. The information processing method according to claim 1, further comprising by the processor, setting learning accuracy included in the learning result as a first variable and a value related to a model size included in the learning result as a second variable, and generating relationship information in which the first variable and the second variable are associated with each of the weights.

6. The information processing method according to claim 5, further comprising: by the processor,
acquiring a first value of the first variable and a second value of the second variable; and
specifying each weight corresponding to the first value and the second value, based on the relationship information.

7. The information processing method according to claim 1, wherein
the weight learning model includes a model that is a linear combination of the first learning model, the second learning model, and the third learning model, with weights being given to the first learning model, the second learning model, and the third learning model, respectively.

8. An information processing apparatus comprising:
a memory; and
one or a plurality of processors, wherein
the memory stores a predetermined learning model using a neural network, and a weight learning model, in which each model including at least two models from among a first learning model subjected to distillation processing, a second learning model subjected to pruning processing, and a third learning model subjected to quantization processing is weighted, for the predetermined learning model, and
the one or plurality of processors execute:
acquiring predetermined learning data;
performing machine learning by inputting the predetermined learning data to the weight learning model;
acquiring a learning result in a case where the machine learning is performed by inputting the predetermined learning data for each weight learning model in which a weight of each of the models is changed;
performing supervised learning by using learning data including each weight learning model to which each changed weight is given and each learning result obtained when learned by each of the weight learning models; and
generating a prediction model that predicts a learning result for each set of weights in a case where arbitrary learning data is input by the supervised learning.

9. A non-transitory computer-readable storage medium on which a program is recorded, the program causing one or a plurality of processors included in an information processing apparatus to execute:
acquiring predetermined learning data;
performing machine learning by inputting the predetermined learning data to a weight learning model, in which each model including at least two models from among a first learning model subjected to distillation processing, a second learning model subjected to pruning processing, and a third learning model subjected to quantization processing is weighted, for a predetermined learning model using a neural network;
acquiring a learning result in a case where the machine learning is performed by inputting the predetermined learning data for each weight learning model in which a weight of each of the models is changed;
performing supervised learning by using learning data including each weight learning model to which each changed weight is given and each learning result obtained when learned by each of the weight learning models; and
generating a prediction model that predicts a learning result for each set of weights in a case where arbitrary learning data is input by the supervised learning.
